(19) United States
(12) Patent Application Publication
(10) Pub. No.: US 2026/0338069 A1
(43) Pub. Date: Oct. 29, 2026

(54) Portable Integrated Intelligent Check Valve For Monitoring And Pressure Relief For Subway Tunnels

(71) Applicants: China Institute of Water Resources and Hydropower Research, Beijing (CN); Beijing Hydrological Station, Beijing (CN); China University of Geosciences (Beijing), Beijing (CN)

(72) Inventors: Shu Yu, Beijing (CN); Penghai Yin, Beijing (CN); Longgang Du, Beijing (CN); Xiong Wu, Beijing (CN); Chang Liu, Beijing (CN); Liqiu Ma, Beijing (CN); Yijie Wang, Beijing (CN); Hongyan Zhao, Beijing (CN); Zuyu Chen, Beijing (CN); Minshi Li, Beijing (CN); Wenping Mu, Beijing (CN); Ziyu Lv, Beijing (CN); Suizi Jia, Beijing (CN); Ziqi Yan, Beijing (CN)

(21) Appl. No.: 19/369,620

(22) Filed: Oct. 27, 2025

(30) Foreign Application Priority Data
Apr. 23, 2025 (CN) 2025105155609

(51) Int. Cl. E21F 16/02; E21F 17/18; F16K 15/03; F16K 37/00

(52) U.S. Cl. CPC E21F 16/02; E21F 17/18; F16K 15/03; F16K 37/005

(57) ABSTRACT

A portable integrated intelligent check valve for monitoring and pressure relief for subway tunnels includes a valve body having one end connected to a water inlet pipe and the other end provided with a water outlet end. The valve body includes a valve core, a monitoring unit, and a swing-type pressure relief structure. The monitoring unit is arranged on an outer side of the water inlet pipe. The swing-type pressure relief structure is arranged on a top of the water inlet pipe. The monitoring unit includes a monitoring contact arm and a monitoring component connected to the monitoring contact arm. The monitoring contact arm extends through the water inlet pipe for monitoring water regime data in the water inlet pipe. The present invention realizes real-time accurate monitoring of groundwater in subway tunnels, intelligent pressure relief and integrated collaborative management of monitoring, effectively improving the safety and stability of subway tunnels.

### CROSS-REFERENCE TO RELATED APPLICATION

This application claims priority to and the benefit of Chinese invention patent Application No. 202510515560.9 filed Apr. 23, 2025 now issued as Chinese Invention Patent No. CN 120159983B on Sep. 5, 2025 which is incorporated by reference in its entirety.

### TECHNICAL FIELD

The present invention relates to the technical field of tunnel engineering monitoring, in particular to a portable integrated intelligent check valve for monitoring and pressure relief for subway tunnels.

### BACKGROUND ART

In the process of tunnel engineering construction and operation, effective monitoring and reasonable control of groundwater are key factors to ensure engineering safety and stability. As an important infrastructure of urban transportation, subway tunnels have complex internal environments and are extremely vulnerable to the impact of groundwater.

However, the existing technology has many problems in the monitoring and control of groundwater in subway tunnels:
(1) Imperfect monitoring means: traditional monitoring methods mostly rely on manual regular detection, which is inefficient and cannot obtain data in real time. Manual detection not only consumes a lot of manpower and time, but also due to the long subway tunnel lines and complex environment, it is difficult to fully cover, and monitoring blind areas are prone to occur. For example, in some areas with complex geological conditions, groundwater conditions change rapidly, and manual detection is difficult to keep up with the changing rhythm, resulting in failure to timely discover potential safety hazards. In addition, manual detection also has human errors, which affect the accuracy of monitoring data.
(2) Single control method and lack of intelligence: most of the existing pressure relief control devices have simple structures and single functions. Many check valves can only realize the basic check function and cannot be flexibly adjusted according to the actual situation of groundwater. When facing changes in groundwater pressure, flow rate and water quality, traditional devices cannot make timely and accurate responses, for example, when the water pressure suddenly increases, the pressure relief volume cannot be automatically adjusted, which may lead to excessive water pressure in the tunnel and damage the tunnel structure; when the water quality is poor, impurities are likely to block the valve, affecting its normal operation and reducing the reliability and service life of the device.
(3) Disconnection between monitoring and control: at present, the monitoring system and the pressure relief control system are independent of each other, and data cannot be shared and collaboratively processed in real time. The monitored groundwater data cannot be timely fed back to the pressure relief control link, resulting in failure to perform precise control according to the actual situation. This makes the groundwater management of the entire subway tunnel lack systematicness and effectiveness, unable to realize comprehensive and efficient management of groundwater, and reduces the ability of subway tunnels to deal with groundwater problems.

### SUMMARY OF THE INVENTION

In order to overcome the deficiencies of the existing technology, an objective of the present invention is to provide a portable integrated intelligent check valve for monitoring and pressure relief for subway tunnels realizes real-time accurate monitoring of groundwater in subway tunnels, intelligent pressure relief and integrated collaborative management of monitoring, effectively improving the safety and stability of subway tunnels.

To achieve the above objective, the present invention provides the following solution: a portable integrated intelligent check valve for monitoring and pressure relief for subway tunnels, which includes a valve body having one end connected to a water inlet pipe and the other end provided with a water outlet end, the valve body being provided therein with a valve core, and further includes a monitoring unit and a swing-type pressure relief structure, where the monitoring unit is arranged on an outer side of the water inlet pipe, the swing-type pressure relief structure is arranged on a top of the water inlet pipe, the monitoring unit is composed of a monitoring component and a monitoring contact arm, the monitoring component is connected to the monitoring contact arm, and the monitoring contact arm extends through the water inlet pipe for monitoring water regime data in the water inlet pipe.

Preferably, the monitoring component includes a plurality of groups of sensor components and a data integration module, the plurality of groups of sensor components are respectively connected to the data integration module, and the plurality of groups of sensor components are connected in parallel.

Preferably, the plurality of groups of sensor components include a pressure sensor, a flow sensor and a pH value sensor, the pressure sensor is respectively connected to the data integration module and the monitoring contact arm through a first transmission channel, for monitoring water pressure and transmitting a water pressure signal to the data integration module; the flow sensor is respectively connected to the data integration module and the monitoring contact arm through a second transmission channel, for monitoring inlet flow rate and transmitting a flow signal to the data integration module; the pH value sensor is respectively connected to the data integration module and the monitoring contact arm through a third transmission channel, for monitoring water quality pH value and transmitting a signal to the data integration module.

Preferably, the monitoring component further includes a power module, the power module is a built-in battery, which is respectively electrically connected to the data integration module, the pressure sensor, the flow sensor and the pH value sensor, and the pressure sensor, the flow sensor and the pH value sensor are electrically connected in parallel.

Preferably, the data integration module includes a signal receiving module having one end connected to the plurality of groups of sensor components for receiving monitoring data and the other end connected to a data processing module, the data processing module is used for analyzing and processing the received signal data of the water pressure, the inlet flow rate and the water quality pH value, including acquiring displacement according to the inlet flow rate, setting a set threshold, comparing the water pressure data collected by the monitoring component with the set threshold, if the water pressure is not less than the set threshold, a valve disc of the swing-type pressure relief structure opens for pressure relief, discharging the pressure exceeding the set threshold, so as to monitor and regulate the water pressure around the subway tunnel to realize pressure relief.

Preferably, the data integration module further includes a storage module, an early warning module and a wireless transmitting module, the storage module is connected to the data processing module for storing the processed signal data; the early warning module is connected to the data processing module for judging whether to send an early warning signal according to the processed signal data; the wireless transmitting module is respectively connected to the data processing module and the early warning module for wirelessly transmitting the processed signal data and early warning signal to an external terminal.

Preferably, the swing-type pressure relief structure includes the valve disc fixedly connected with a rocker arm, the rocker arm is connected to a bracket through a hinge pin, the bracket is fixed inside the valve body, the valve disc rotates around the hinge pin for controlling opening and closing of the water inlet pipe in the valve body, and a valve seat is provided at the top of the water inlet pipe, and a sealing gasket is arranged at a contact part between the valve seat and the valve disc.

Preferably, a limiting plate is arranged inside the valve core, the limiting plate is fixed on an inner wall of the valve body, for limiting a rotation angle of the valve disc and preventing the valve disc from being excessively opened or closed.

Preferably, an outer surface of the valve body is symmetrically provided with a plurality of groups of stabilizing wings, the stabilizing wings are fixedly connected to an outer wall of the valve body, for enhancing stability of the valve body during installation in the subway tunnel; a sand blocking net is arranged above the monitoring contact arm, two ends of the sand blocking net are respectively fixedly connected to two sides of the inner wall of the water inlet pipe, for intercepting sand impurities in the water inlet pipe.

Preferably, a casing pipe is arranged at the water outlet end, an inner diameter of the casing pipe is larger than a diameter of the valve body, the casing pipe is sleeved on the outer surface of the valve body, and clamping pieces are respectively arranged on outer surfaces of two sides of the casing pipe, and the valve body is connected to the grouting hole in the subway tunnel through the clamping pieces, facilitating installation and disassembly.

According to the specific embodiment provided by the present invention, the present invention discloses the following technical effects:
(1) The present invention can obtain real-time water regime data such as water pressure, flow rate and water quality pH value in the water inlet pipe by setting a monitoring component including a pressure sensor, a flow sensor and a pH value sensor. These sensors are connected to the data integration module, and a plurality of groups of sensor components are connected in parallel, ensuring the stability and independence of data collection. The signal receiving module in the data integration module receives monitoring data, which is analyzed and processed by the data processing module and stored by the storage module, realizing accurate monitoring and recording of relevant data in the subway tunnel and providing a reliable basis for subsequent decision-making.
(2) In the present invention, the early warning module and the wireless transmitting module in the data integration module are used. When the processed signal data exceeds the preset range, the early warning module sends an early warning signal, and the data and the early warning signal are transmitted to the external terminal through the wireless transmitting module. At the same time, a valve disc of a swing-type pressure relief structure can rotate around the hinge pin for pressure relief when the water pressure is abnormal according to the actual situation, and the limiting plate limits the rotation angle of the valve disc to ensure the safety and reliability of the pressure relief process. This intelligent control method can automatically adjust the valve state according to the monitoring data, realizing intelligent control of water flow and pressure in the subway tunnel. Compared with traditional valves with single functions, it can better cope with complex groundwater environment changes.
(3) The present invention enhances the stability during installation in the subway tunnel by arranging stabilizing wings on the outer surface of the valve body; the sand blocking net above the monitoring contact arm can intercept sand impurities, protect sensors and valve components, and prolong the service life of the equipment. The design of the casing pipe and clamping pieces at the water outlet end enables the valve body to be connected to the grouting hole in the subway tunnel through the clamping pieces, facilitating installation and disassembly, facilitating daily maintenance and replacement of the equipment, reducing maintenance costs and improving the operating efficiency of relevant facilities in the subway tunnel.
(4)The present invention utilizes a pressure sensor to measure water pressure, and obtains displacement based on flow sensor data combined with check valve opening time, meanwhile achieves feedback control by setting a set threshold in the data integration module. Specifically, when the water pressure is not less than the set threshold, a valve disc of the swing-type pressure relief structure opens for pressure relief, discharging the pressure exceeding the threshold, achieving a decompression effect, avoiding deformation caused by excessive water pressure around the subway tunnel, especially in the case of inconsistent pressure in the tunnel circumferential direction, which can effectively prevent uneven deformation of tunnel segments, thereby avoiding cracking at the joints and keeping the water pressure around the subway tunnel at an appropriate value.

### BRIEF DESCRIPTION OF THE DRAWINGS

In order to more clearly illustrate the embodiments of the present invention or the technical solutions in the prior art, the drawings needed in the embodiments will be briefly introduced below. Obviously, the drawings in the following description are only some embodiments of the present invention. For a person skilled in the art, other drawings can be obtained according to these drawings without creative labor.

FIG. 1 is a structural cross-sectional view according to Embodiment 1 of the present invention;

FIG. 2 is a schematic diagram of a connection relationship of a monitoring unit according to Embodiment 1 of the present invention; and

FIG. 3 is a schematic diagram of a connection relationship of a data integration module according to Embodiment 1 of the present invention.

### REFERENCE NUMERALS

1. Valve body; 2. Water inlet pipe; 3. Sand blocking net; 4. Limiting plate; 5. Bracket; 6. Rocker arm; 7. Valve disc; 8. Valve seat; 9. Hinge pin; 10. Monitoring component; 11. Monitoring contact arm; 12. Valve core; 13. Water outlet end; 14. Casing pipe; 15. Clamping piece; 16. Stabilizing wing; 17. Power module; 18. Pressure sensor; 19. Flow sensor; 20. pH value sensor; 21. Data integration module; 22. First transmission channel; 23. Second transmission channel; 24. Third transmission channel; 25. Signal receiving module; 26. Data processing module; 27. Storage module; 28. Early warning module; 29. Wireless transmitting module.

### DETAILED DESCRIPTION OF THE INVENTION

The following will clearly and completely describe the technical solutions in the embodiments of the present invention with reference to the drawings in the embodiments of the present invention. Obviously, the described embodiments are only a part of the embodiments of the present invention, not all of them. Based on the embodiments of the present invention, all other embodiments obtained by a person skilled in the art without making creative labor shall fall within the protection scope of the present invention.

To make the above objectives, features and advantages of the present invention more obvious and understandable, the present invention will be described in further detail below with reference to the drawings and specific implementations.

### Embodiment 1

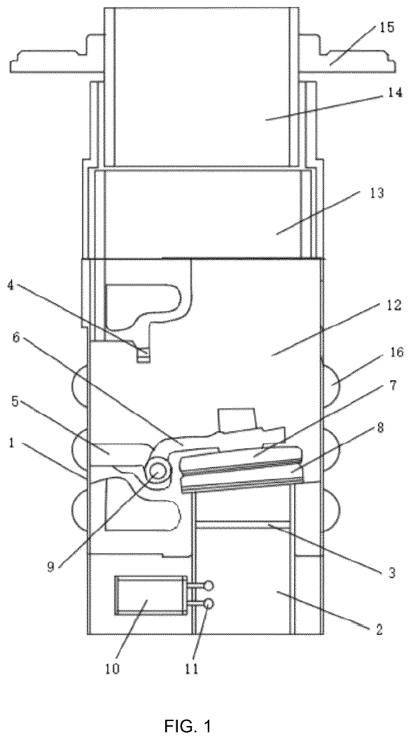

As shown in FIG. 1, a portable integrated intelligent check valve for monitoring and pressure relief for subway tunnels provided in the present embodiment is mainly composed of a valve body 1, a water inlet pipe 2, a water outlet end 13, a valve core 12, a monitoring unit and a swing-type pressure relief structure. The valve body 1 has one end connected to the water inlet pipe 2 and the other end provided with a water outlet end 13, and the valve core 12 is installed inside the valve body 1. The monitoring unit is located on one outer side of the water inlet pipe 2 and is composed of a monitoring component 10 and a monitoring contact arm 11. The monitoring contact arm 11 extends through the water inlet pipe 2 and is used to collect water regime data. The monitoring component 10 includes a plurality of groups of sensor components, a data integration module 21 and a power module 17. The plurality of groups of sensor components include a pressure sensor 18, a flow sensor 19 and a pH value sensor 20, which are respectively connected to the data integration module 21 and the monitoring contact arm 11 through a first transmission channel 22, a second transmission channel 23 and a third transmission channel 24, and these sensor components are connected in parallel to ensure the stability and independence of data collection. The pressure sensor 18 is a high-precision strain gauge pressure sensor with a measurement accuracy of up to ±0.5% FS and a range of 0 -10 MPa, which can accurately measure the pressure changes of groundwater in the subway tunnel. The flow sensor 19 is an electromagnetic flow sensor with a measurement accuracy of ±1% and a range of 0-50 m³/h, which can meet the measurement requirements under different flow conditions. The pH value sensor 20 is a glass electrode pH sensor with a measurement accuracy of ±0.01 pH and a measurement range of 0-14 pH, which can accurately monitor the pH value of groundwater. In addition, the first transmission channel 22, the second transmission channel 23 and the third transmission channel 24 all adopt shielded twisted pairs to reduce external electromagnetic interference and ensure that the data collected by the sensors is accurately transmitted to the data integration module 21. The core material of the transmission channels is high-purity oxygen-free copper, which has the characteristics of low resistance and high conductivity, ensuring the stability of signal transmission.

The swing-type pressure relief structure is disposed on the top of the water inlet pipe 2 and includes a valve disc 7, a hinge pin 9, a bracket 5 and a valve seat 8. The valve disc 7 is fixedly connected with a rocker arm 6, the rocker arm 6 is connected with the bracket 5 fixed inside the valve body 1 through the hinge pin 9, and the valve disc 7 can rotate around the hinge pin 9 to realize control of opening and closing of the water inlet pipe 2. The valve seat 8 is located at the top of the water inlet pipe 2, and a sealing gasket is provided at the contact part with the valve disc 7 to enhance the sealing effect.

The outer surface of the valve body 1 is symmetrically provided with a plurality of groups of stabilizing wings 16, and the stabilizing wings 16 are fixedly connected to the outer wall of the valve body 1 to enhance the stability of the valve body during installation in the subway tunnel. A sand blocking net 3 is provided above the monitoring contact arm 11, and its both ends are fixed on both sides of the inner wall of the water inlet pipe 2 to intercept sand impurities and protect the sensors and valve components. A casing pipe 14 is provided at a water outlet end 13, has an inner diameter being larger than the diameter of the valve body 1, and is sleeved on the outer surface of the valve body 1. Clamping pieces 15 are provided on the outer surfaces of both sides of the casing pipe 14, and the valve body 1 is connected to the grouting hole in the subway tunnel through the clamping pieces 15, facilitating installation and disassembly.

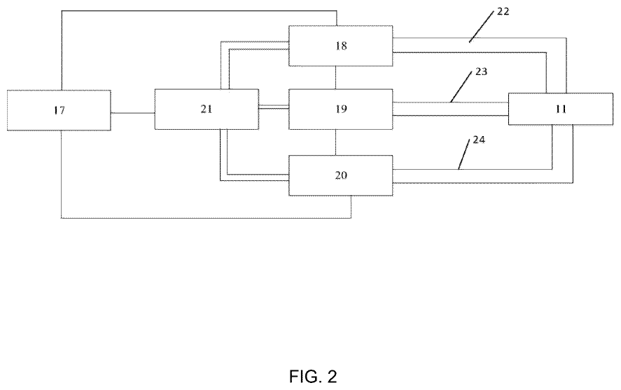

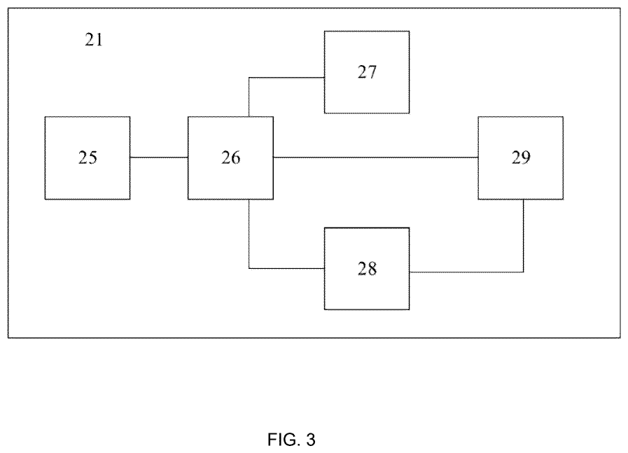

In addition, the monitoring component 10 mainly realizes its functions through the data integration module 21. Combined with FIG. 2 and FIG. 3, the data integration module 21 includes a signal receiving module 25, a data processing module 26, a storage module 27, an early warning module 28 and a wireless transmitting module 29. The water pressure, flow rate and water quality pH value data collected by the pressure sensor 18, the flow sensor 19 and the pH value sensor 20 are transmitted to the signal receiving module 25 through their respective transmission channels. After receiving the monitoring data, the signal receiving module 25 transmits them to the data processing module 26. The data processing module 26 analyzes and processes the received data, for example, compares it with the preset normal range values. Secondly, the power module 17 is a built-in battery, which is respectively electrically connected to the data integration module 21, the pressure sensor 18, the flow sensor 19 and the pH value sensor 20 to provide stable electrical energy for various components. The pressure sensor 18, the flow sensor 19 and the pH value sensor 20 are electrically connected in parallel to ensure that each sensor works independently without mutual interference. The power module 17 has overcharge protection, over-discharge protection and battery level monitoring functions to prevent the battery from being damaged due to overcharging or over-discharging. At the same time, it can monitor the battery level in real time. When the battery level is lower than the preset value of 10%, it sends early warning information of low battery to the external terminal through the wireless transmitting module 29 to remind the staff to replace it in time.

The data processing module 26 also has a function of processing water pressure and displacement data. The water pressure data collected by the pressure sensor 18 is transmitted to the data processing module 26 in real time and then compared with the preset pressure threshold. The flow rate data collected by the flow sensor 19 is combined with the check valve opening time, and the displacement is calculated by the data processing module 26, and the displacement data is analyzed. If the water pressure is not less than the set threshold, the data processing module 26 issues an instruction to control the valve disc 7 of the swing-type pressure relief structure to rotate around the hinge pin 9 to open for pressure relief operation; when the water pressure is lower than the set threshold, the valve disc 7 remains closed. During the whole process, if an abnormality occurs in water pressure or displacement, the early warning module 28 issues early warning signals of different levels according to the degree of abnormality, and the wireless transmitting module 29 transmits the water pressure, displacement data and early warning signals to the external terminal. It should be noted that opening and closing of the valve disc 7 is only determined by the relationship between the water pressure, displacement and the set threshold, and has nothing to do with the water quality monitoring data. The purpose of the water quality monitoring data is to realize effective management of the water regime in the subway tunnel.

If the data processing module 26 judges that the data exceeds the normal range, it stores the processed data to the storage module 27 and triggers the early warning module 28 at the same time. The early warning module 28 issues early warning signals of different levels according to the degree of exceeding the range, such as a yellow early warning for slight abnormality and a red early warning for serious abnormality. The wireless transmitting module 29 transmits the processed signal data and early warning signals to the external terminal through wireless communication methods such as Bluetooth, Wi-Fi or LoRa, such as computers in the monitoring room or handheld devices of staff, so that the staff can timely understand the situation of groundwater in the subway tunnel. At the same time, the valve disc 7 rotates to open around the hinge pin 9 under the action of water pressure, and groundwater is discharged from the water outlet end 13 through the water inlet pipe 2 and the valve body 1. The discharged water is diverted to the drainage system of the subway tunnel through the casing pipe 14 and pipes connected to the outside, avoiding damage to the track and pipe fittings by water flow, thereby realizing the pressure relief function. In addition, a limiting plate 4 is fixed on the inner wall of the valve body 1 to limit the rotation angle of the valve disc 7, prevent the valve disc 7 from over-opening or over-closing, and ensure the safety and reliability of the pressure relief process.

Working principle: first, the check valve provided in the present embodiment is inserted into the reserved grouting hole of the subway tunnel and fixed. Then, under the action of water pressure, the valve disc 7 and the rocker arm 6 in the swing-type pressure relief structure are connected to the bracket 5 through the hinge pin 9. When the water pressure is large enough, the valve disc 7 and the rocker arm 6 rotate around the hinge pin 9 to open, and the sealing gasket at the contact part between the valve seat 8 at the top of the water inlet pipe 2 and the valve disc 7 no longer fits tightly. Groundwater will be discharged from the water outlet end 13 through the water inlet pipe 2 and the valve body 1, and the groundwater is diverted to the drainage system of the subway tunnel through the casing pipe 14 and externally provided drainage pipes, thereby realizing pressure relief. At the same time, the monitoring component 10 starts to work, the monitoring contact arm 11 starts to monitor groundwater information, and the corresponding pressure sensor 18, the flow sensor 19 and the pH value sensor 20 continuously collect water regime data in the water inlet pipe 2 to obtain water pressure, inlet flow rate and water quality pH value information respectively. Subsequently, the collected signal data is stably and independently transmitted to the signal receiving module 25 in the data integration module 21 through the respective corresponding first transmission channel 22, second transmission channel 23 and third transmission channel 24. After receiving the signal data, the signal receiving module 25 transmits it to the data processing module 26 for processing. During this process, the data processing module 26 can obtain the displacement according to the monitoring of the flow sensor 18, and the set threshold in the data processing module 26 is compared with the collected water pressure data. Specifically, if the water pressure is greater than or equal to the set threshold, the valve disc 7 is immediately controlled to open for pressure relief; if the water pressure is lower than the threshold, the valve disc 7 remains closed. During the entire operation process, the water pressure and displacement are continuously monitored. Once an abnormality occurs, the early warning module 28 issues an early warning, and the wireless transmitting module 29 transmits relevant data and early warning information to the external terminal. In addition, the entire process aims to ensure that the water pressure around the tunnel is appropriate, and at the same time provides auxiliary data support for water quality monitoring. Subsequently, on the one hand, the processed signal data is stored in the storage module 27 for subsequent query and analysis; on the other hand, if the processed signal data exceeds the normal threshold, preferably when the pH value of groundwater is acidic or alkaline, the data processing module 26 will send signals to the early warning module 28 and the wireless transmitting module 29 respectively; after receiving the signal, the early warning module 28 will immediately activate the early warning mechanism. According to the preset different degrees of pH value abnormality, early warning signals of different levels are issued. When the pH value is slightly lower or higher than the normal range, a yellow early warning is issued to remind the staff to pay attention to changes in groundwater quality; if the pH value seriously deviates from the normal range and may cause major damage to the tunnel structure, a red early warning is issued to warn the staff that immediate measures must be taken. At the same time, after receiving the signal from the data processing module 26, the wireless transmitting module 29 will transmit the processed signal data including abnormal groundwater pH value and early warning information to the external terminal through wireless communication. The external terminal can be computer equipment in the monitoring center or mobile terminals carried by staff. The staff in the monitoring center can intuitively view the abnormal situation of groundwater pH value and the specific location where the abnormality occurs through special monitoring software. Therefore, adopting the above-mentioned portable integrated intelligent check valve for monitoring and pressure relief for subway tunnels realizes real-time accurate monitoring of groundwater in subway tunnels, intelligent pressure relief and integrated collaborative management of monitoring, effectively improving the safety and stability of subway tunnels.

Specific examples are used herein to elaborate the principles and implementations of the present invention. The description of the above embodiments is only used to help understand the method and its core idea of the present invention; meanwhile, for a person skilled in the art, based on the idea of the present invention, there will be changes in the specific implementations and application scopes. In conclusion, the content of this specification should not be construed as a limitation of the present invention.

1. A portable integrated intelligent check valve for monitoring and pressure relief for subway tunnels, comprising a valve body having one end connected to a water inlet pipe and the other end provided with a water outlet end, the valve body being provided therein with a valve core, characterized by further comprising a monitoring unit and a swing-type pressure relief structure, wherein the monitoring unit is arranged on an outer side of the water inlet pipe, the swing-type pressure relief structure is arranged on a top of the water inlet pipe, the monitoring unit is composed of a monitoring component and a monitoring contact arm, the monitoring component is connected to the monitoring contact arm, and the monitoring contact arm extends through the water inlet pipe for monitoring water regime data in the water inlet pipe;
the monitoring component comprises a plurality of groups of sensor components and a data integration module, the plurality of groups of sensor components are respectively connected to the data integration module, and the plurality of groups of sensor components are connected in parallel; the plurality of groups of sensor components comprise a pressure sensor, a flow sensor and a pH value sensor, the pressure sensor is respectively connected to the data integration module and the monitoring contact arm through a first transmission channel, for monitoring water pressure and transmitting a water pressure signal to the data integration module; the flow sensor is respectively connected to the data integration module and the monitoring contact arm through a second transmission channel, for monitoring inlet flow rate and transmitting a flow signal to the data integration module; the pH value sensor is respectively connected to the data integration module and the monitoring contact arm through a third transmission channel, for monitoring water quality pH value and transmitting a signal to the data integration module;
the data integration module comprises a signal receiving module having one end connected to the plurality of groups of sensor components for receiving monitoring data and the other end connected to a data processing module, the data processing module is used for analyzing and processing the received signal data of the water pressure, the inlet flow rate and the water quality pH value, including acquiring displacement according to the inlet flow rate, setting a set threshold, comparing the water pressure data collected by the monitoring component with the set threshold, if the water pressure is not less than the set threshold, a valve disc of the swing-type pressure relief structure opens for pressure relief, discharging the pressure exceeding the set threshold, so as to monitor and regulate the water pressure around the subway tunnel to realize pressure relief;
an outer surface of the valve body is symmetrically provided with a plurality of groups of stabilizing wings, the stabilizing wings are fixedly connected to an outer wall of the valve body, for enhancing stability of the valve body during installation in the subway tunnel; a sand blocking net is arranged above the monitoring contact arm, two ends of the sand blocking net are respectively fixedly connected to two sides of the inner wall of the water inlet pipe, for intercepting sand impurities in the water inlet pipe.

2. The portable integrated intelligent check valve for monitoring and pressure relief for subway tunnels according to claim 1, wherein the monitoring component further comprises a power module, the power module is a built-in battery, which is respectively electrically connected to the data integration module, the pressure sensor, the flow sensor and the pH value sensor, and the pressure sensor, the flow sensor and the pH value sensor are electrically connected in parallel.

3. The portable integrated intelligent check valve for monitoring and pressure relief for subway tunnels according to claim 1, wherein the data integration module further comprises a storage module, an early warning module and a wireless transmitting module, the storage module is connected to the data processing module for storing the processed signal data; the early warning module is connected to the data processing module for judging whether to send an early warning signal according to the processed signal data; the wireless transmitting module is respectively connected to the data processing module and the early warning module for wirelessly transmitting the processed signal data and early warning signal to an external terminal.

4. The portable integrated intelligent check valve for monitoring and pressure relief for subway tunnels according to claim 1, wherein the swing-type pressure relief structure comprises the valve disc fixedly connected with a rocker arm, the rocker arm is connected to a bracket through a hinge pin, the bracket is fixed inside the valve body, the valve disc rotates around the hinge pin for controlling opening and closing of the water inlet pipe in the valve body, and a valve seat is provided at the top of the water inlet pipe, and a sealing gasket is arranged at a contact part between the valve seat and the valve disc.

5. The portable integrated intelligent check valve for monitoring and pressure relief for subway tunnels according to claim 4, wherein a limiting plate is arranged inside the valve core, the limiting plate is fixed on an inner wall of the valve body, for limiting a rotation angle of the valve disc and preventing the valve disc from being excessively opened or closed.

6. The portable integrated intelligent check valve for monitoring and pressure relief for subway tunnels according to claim 1, wherein a casing pipe is arranged at the water outlet end, an inner diameter of the casing pipe is larger than a diameter of the valve body, the casing pipe is sleeved on the outer surface of the valve body, and clamping pieces are respectively arranged on outer surfaces of two sides of the casing pipe, and the valve body is connected to the grouting hole in the subway tunnel through the clamping pieces, facilitating installation and disassembly.
